(19) United States
(12) Patent Application Publication
(10) Pub. No.: US 2012/0313288 A1
(43) Pub. Date: Dec. 13, 2012

(54) METHOD AND APPARATUS FOR MANUFACTURING A FILM WITH MARKINGS

(75) Inventors: Helmut MEYER, Troisdorf (DE); Jochen HENNES, Eschborn (DE)

(73) Assignee: Reifenhauser GmbH & Co. KG Maschinenfabrik, Troisdorf (DE)

(21) Appl. No.: 13/462,552

(22) Filed: May 2, 2012

(30) Foreign Application Priority Data
May 3, 2011 (EP) 11003585.4

(51) Int. Cl. B29C 47/88

(52) U.S. Cl. 264/211.12; 425/378.1

(57) ABSTRACT

A method for manufacturing a film that is provided with markings and is based on a thermoplastic plastic. The thermoplastic plastic is melted in an extruder and emerges from an extrusion die in the form of a melt web. The melt web is conveyed away over a surface of at least one cooling roller and cooled to produce the film. In subregions of the surface of the at least one cooling roller corresponding to the markings, the melt web and/or the film being produced from it is acted on with a different cooling action than in a remainder of the surface.

### BACKGROUND OF THE INVENTION

1. Field of the Invention

This invention relates to a method and apparatus for manufacturing a film having markings such as symbols, graphics, letters, and numbers.

2. Discussion of Related Art

It is known to provide a film based on a thermoplastic plastic with markings by printing on the film after it is manufactured. For example, flexographic printing presses are used for this reason, which apply up to seven colors of ink onto the film. This produces markings in the form of images and/or inscriptions.

However, it is often not necessary for such images and inscriptions to be produced in color. A single color, such as “white” is often sufficient. In addition, printing can cause difficulties because, for example, certain products must not contact the applied inks. Also, inks do not by default have the temperature resistance required, such as in freezer bags, because often the inks used do not adhere sufficiently to the film at low temperatures.

Furthermore, printing on films using the known methods is always particularly complex, a situation which needs improvement.

### SUMMARY OF THE INVENTION

One object of this invention is to provide a method and apparatus of the type mentioned above that makes it possible to avoid disadvantages of the prior art.

In one embodiment of this invention, the above object is accomplished with a method defined by the features of this specification and the claims.

An apparatus for attaining the above object is also defined by the features set forth in this specification and in the claims.

Advantageous embodiments and modifications of this invention are further set forth in the respective dependent claims.

The method according to some embodiments of this invention, in the subregions of the surface of the at least one cooling roller corresponding to the markings, the melt web and/or the film being produced from it each is acted on with a different cooling action than the remainder of the surface.

This invention thus makes use of the effect, which is known from the prior art, that cooling the melt web immediately after the exit from the extrusion die by the surface of the cooling roller causes a powerful, occasionally sudden, cooling of the film being produced, which usually gives the film high transparency and high gloss.

If the melt web and/or the film being produced from it is acted on with a different cooling action in the subregions of the surface corresponding to the markings than the remainder of the surface, then during the extrusion process of the film, it is possible to produce selective differences in transparency or gloss and the like, which appear in the form of markings such as images and inscriptions on the film that is thus produced, without requiring a printing process according to the known methods. The production of markings in the form of inscriptions and/or images can thus be carried out in an in-line fashion during the manufacture of the film and the films produced no longer require any preparation or pretreatment steps for the actual printing process, which can also be eliminated.

When manufacturing an intrinsically transparent film, the desired markings in the film can naturally be produced, for example, if a different cooling action prevails in the subregions of the surface corresponding to the markings than in the remaining surface regions of the corresponding cooling roller so that the marking has a lower transparency and lower gloss and shows up in the film as an opaque-looking marking. This is referred to in this specification and/or in the claims as the positive method.

In the same way, however, it is also possible to reserve the powerful cooling action required to achieve the high transparency and high gloss only for the subregion of the surface of the cooling roller in which the markings are to be produced, while the rest or the remainder of the surface regions of the cooling roller are acted on with a lower intensity of cooling action so that these regions have an essentially opaque appearance with a lower transparency and lower gloss. This is referred to in this specification and/or in the claims as the negative method.

Thus, depending on the type of marking production using the positive or negative method, a higher or lower intensity of cooling action is produced in the subregions of the surface corresponding to the markings than in the remainder of the surface of the at least one cooling roller.

The markings that can be produced with the method proposed according to this invention are thus based on cooling-induced local changes in the properties of the film and can be produced by correspondingly equipped cooling rollers as long as the film has not yet completely cooled. Thus, the markings can be produced not only in the region of or near the first cooling roller against which the melt web rests, but also in the region of or near subsequent cooling rollers over which the film being produced from the melt web is guided, provided that the latter has not yet completely cooled. It is also possible to use a combined exertion of different cooling actions across a plurality of cooling rollers to intensify the effect according to this invention. This, however, requires a synchronization of the cooling rollers according to a repeat pattern.

The exertion of different cooling actions on the surface regions of the cooling roller can, for example, be achieved through different intensities of active cooling of the surface regions or by embodying the surface regions to have different thermal conductivities.

In one embodiment according to this invention, the subregions of the surface corresponding to the markings can be composed of a material with a correspondingly higher or lower thermal conductivity than the material for producing the remainder of the surface.

Such a material with a higher or lower thermal conductivity can, for example, be applied to the surface of the at least one cooling roller in the form of a surface coating or can be embodied in the form of an insert piece that is inserted into the surface of the cooling roller, which has a corresponding recess.

In order to produce a lower intensity of cooling action and lower thermal conductivity, suitable heat-insulating materials such as lacquer coatings, paper or plastic layers, and so forth can be applied to the surface of the cooling roller and, depending on the positive or negative method used, can either cover the subregions of the surface corresponding to the markings or can cover the remainder of the surface of the cooling roller.

In another embodiment according to this invention, electrostatic charging can be used to attract the melt web and/or the film being produced from it toward the surface of the at least one cooling roller in order to increase the cooling action and/or to repel it from the roller, to decrease the cooling action. In the subregions of the surface that are intended to produce the marking when they contact the melt web that is being cooled in order to form the film, it is possible to use an appropriate materials selection to weaken or intensify the electrostatic attraction or repulsion in the desired fashion, depending on whether the positive or negative method is used.

In an apparatus according to one embodiment of this invention, for attaining the above object, the surface of the cooling roller in the subregions corresponding to the markings has a different thermal conductivity than the remainder of the surface.

Depending on the positive or negative method, in the thermal conductivity of the subregions corresponding to the markings is higher or lower than the thermal conductivity in the remainder of the surface of the cooling roller.

In addition to coating the subregions corresponding to the markings with a coating of lower thermal conductivity, such as a lacquer or a plastic or paper layer, it is also possible to mount a sleeve-like cover onto the surface of the cooling roller, which has cutouts that correspond to the subregions of the desired markings so that in this region, the underlying surface of the cooling roller is accessible whereas in the remaining subregions, the sleeve-like cover forms the surface of the cooling roller. Depending on the materials selected for the cover, it is thus possible to produce a higher or lower thermal conductivity in this region relative to the surface of the cooling roller.

The cooling rollers can be embodied as both cylindrical and convex. Instead of the above-described sleeve-like cover, it is also possible for a material belt to have a length that corresponds to the circumference of the cooling roller or an additional surface, which has correspondingly different cooling action and/or thermal conductivity in the subregions and in the remaining regions, to be inserted into the transport path of the film being manufactured according to this invention, across which the film is guided after it emerges from the extrusion die.

If the surface of the cooling roller in the region of or near the markings to be produced also has a texturing, the film can also undergo a slight embossing in this region, thus making the markings even more visible and more sharply delineated at the edges.

### BRIEF DESCRIPTION OF THE DRAWINGS

Other embodiments and details of this invention are explained in greater detail in view of an exemplary embodiment shown in the drawings, wherein:

FIG. 1 is a schematic drawing of an apparatus for manufacturing a film provided with markings according to this invention; and

FIG. 2 shows a view of a film according to this invention.

### DESCRIPTION OF PREFERRED EMBODIMENTS

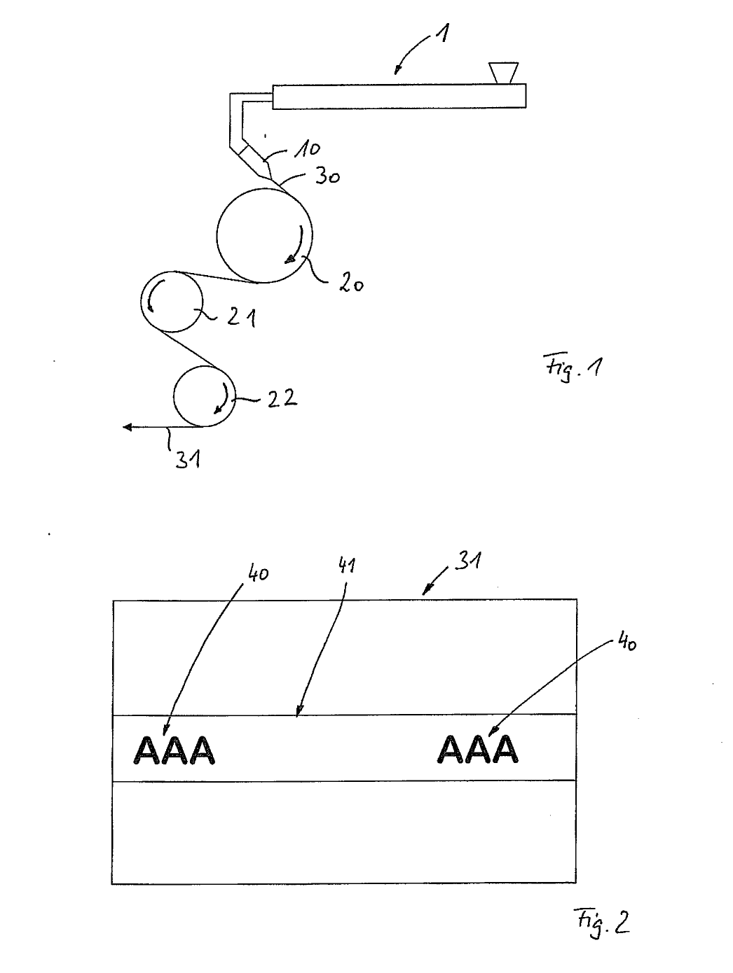

FIG. 1 shows the method and apparatus for manufacturing a film, which has markings, as shown in FIG. 2.

In this embodiment of this invention the film 31, for example, has continuous markings in the form of an uninterrupted bar 41, for example with a slightly opaque appearance on the otherwise transparent film and with regularly repeating inscriptions 40 on it.

In order to manufacture such a film, at least one extruder 1 is used, in which the thermoplastic plastic being used is transformed in an intrinsically known manner into a melt that then emerges in the form of a melt web 30 from an extrusion die 10 situated or positioned downstream of the extruder 1 and is laid against a first cooling roller 20. The cooling roller 20 is temperature-controlled and is driven in a rotary fashion in the rotation direction indicated by the arrows. With the cooled surface of the cooling roller 20 and the existing temperature gradients relative to the melt web 30 that is laid against it, a cooling action is exerted on the melt web 30, which cools it within an extremely short time so that the melt web 30, in the course of resting against the cooling roller 20, is gradually cooled to form the film 31 and is also given its high transparency and gloss.

In addition, the film 31 produced is subsequently also guided over two additional cooling rollers 21, 22 shown here by way of example, before being delivered for further processing.

In the region of or near the surface of each individual cooling roller 20, 21, 22 in which the cooling of the melt web 30 to form the film 31 has not yet been entirely completed, the gradual change in the cooling action can be used to influence the transparency and the gloss of the film 31.

If one or more of the cooling rollers 20, 21, 22 is then equipped with a different cooling action over its longitudinal axis perpendicular to a plane of the drawing in FIG. 1, for example, in the region in which the markings 40, 41 are to be produced, is equipped with a coating having a lower thermal conductivity than the remaining surface regions of the cooling roller 20, 21, or 22, then this produces the continuous markings 40, 41 as shown in FIG. 2 on the surface.

One significant effect can be achieved in the region of or near the first cooling roller 20, however, an additional marking 40, 41 of this type in the surface of the film 31 can also be produced in the region of the other cooling rollers 21, 22.

With the above-explained method and apparatus, it is thus possible for films based on a thermoplastic plastic to be provided with markings in the form of inscriptions and/or images and so forth, which are produced in a continuously repeating pattern on the surface of the film without requiring additional printing. Because this does not use any printing inks, but rather a change in the structure with regard to the level of transparency and/or gloss in order to produce the markings, there are no problems with printing inks that may possibly contaminate a packaged good and/or with a lack of adhesion of the printing inks to the plastic film.

This can also achieve significant cost reductions in the manufacture of such films provided with markings.

European Patent Application No. 11003585.4, filed 3 May 2011, the priority document corresponding to this invention, to which a foreign priority benefit is claimed under Title 35, United States Code, Section 119, and its entire teachings are incorporated, by reference, into this specification.

What is claimed is:

1. A method for manufacturing a film (31) having markings (40, 41) and of a thermoplastic plastic, wherein the thermoplastic plastic is melted in an extruder (1) and emerges from an extrusion die (10) in a form of a melt web (30), and is conveyed away over a surface of at least one cooling roller (20, 21, 22) and cooled to produce the film (31), the method comprising in subregions of the surface of the at least one cooling roller (20, 21, 22) corresponding to the markings (40, 41), the melt web (30) and/or the film (31) being produced having a different cooling action than in a remainder of the surface.

2. The method as recited in claim 1, wherein in the subregions of the surface corresponding to the markings (40, 41), a higher intensity or a lower intensity of cooling action being produced than in the remainder of the surface of the at least one cooling roller (20, 21, 22).

3. The method as recited in claim 2, wherein the subregions of the surface corresponding to the markings (40, 41) are of a material with a higher thermal conductivity or a lower thermal conductivity than a material used to produce the remainder of the surface.

4. The method as recited in claim 3, wherein the material with the higher thermal conductivity or the lower thermal conductivity is applied as a surface coating onto the surface of the at least one cooling roller (20, 21, 22) or is formed as an insert piece inserted into the surface of the at least one cooling roller (20, 21, 22), which has been provided with a corresponding recess.

5. The method as recited in claim 4, wherein an electrostatic charging is used to attract the melt web (30) and/or the film (31) produced toward the surface of the at least one cooling roller (20, 21, 22) or to repel it from the surface of the at least one cooling roller (20, 21, 22).

6. The method as recited in claim 5, wherein the action of the electrostatic charging in the subregions of the surface corresponding to the markings differs from the action in the remainder of the surface.

7. An apparatus for manufacturing a film (31) having markings (40, 41) and of a thermoplastic plastic, including at least one extruder (1) for producing a melt from the thermoplastic plastic and an extrusion die (10) positioned downstream of the at least one extruder, and at least one cooling roller (20, 21, 22) contacting a melt web (30) output by the extrusion die (10), the apparatus comprising the surface of the at least one cooling roller (20, 21, 22) in subregions of the surface corresponding to the markings (40, 41) having a different thermal conductivity than a remainder of the surface.

8. The apparatus as recited in claim 7, wherein a thermal conductivity of the subregions corresponding to the markings (40, 41) is higher or lower than a second thermal conductivity of the remainder of the surface of the at least one cooling roller (20, 21, 22).

9. The apparatus as recited in claim 8, wherein the surface of the cooling roller (20, 21, 22) has a coating with a lower thermal conductivity in the subregions corresponding to the markings (40, 41).

10. The apparatus as recited in claim 9, wherein the coating is of a lacquer or a paper or a plastic layer.

11. The apparatus as recited in claim 8, wherein a sleeve-like cover with cutouts that correspond to the subregions of the markings (40, 41) is mounted onto the surface of the at least one cooling roller (20, 21, 22) and the sleeve-like cover is of a material with a higher thermal conductivity or a lower thermal conductivity than the surface of the at least one cooling roller (20, 21, 22).

12. The method as recited in claim 1, wherein the subregions of the surface corresponding to the markings (40, 41) are of a material with a higher thermal conductivity or a lower thermal conductivity than a material used to produce the remainder of the surface.

13. The method as recited in claim 12, wherein the material with the higher thermal conductivity or the lower thermal conductivity is applied as a surface coating onto the surface of the at least one cooling roller (20, 21, 22) or is formed as an insert piece inserted into the surface of the at least one cooling roller (20, 21, 22), which has been provided with a corresponding recess.

14. The method as recited in claim 1, wherein an electrostatic charging is used to attract the melt web (30) and/or the film (31) produced toward the surface of the at least one cooling roller (20, 21, 22) or to repel it from the surface of the at least one cooling roller (20, 21, 22).

15. The method as recited in claim 14, wherein the action of the electrostatic charging in the subregions of the surface corresponding to the markings differs from the action in the remainder of the surface.

16. The apparatus as recited in claim 7, wherein the surface of the cooling roller (20, 21, 22) has a coating with a lower thermal conductivity in the subregions corresponding to the markings (40, 41).

17. The apparatus as recited in claim 16, wherein the coating is of a lacquer or a paper or a plastic layer.

18. The apparatus as recited in claim 7, wherein a sleeve-like cover with cutouts that correspond to the subregions of the markings (40, 41) is mounted onto the surface of the at least one cooling roller (20, 21, 22) and the sleeve-like cover is of a material with a higher thermal conductivity or a lower thermal conductivity than the surface of the at least one cooling roller (20, 21, 22).
